(19) United States
(12) Patent Application Publication
(10) Pub. No.: US 2024/0014381 A1
(43) Pub. Date: Jan. 11, 2024

(54) A POSITIVE ELECTRODE ACTIVE MATERIAL FOR RECHARGEABLE LITHIUM-ION BATTERIES

(71) Applicants: UMICORE, Brussels (BE); UMICORE KOREA LTD., Cheonan, Chungcheongnam-do (KR)

(72) Inventors: Shinichi KUMAKURA, Brussels (BE); TaeHyeon YANG, Chungcheongnam-do (KR); Jens Martin PAULSEN, Chungcheongnam-do (KR)

(21) Appl. No.: 18/253,446

(22) PCT Filed: Nov. 26, 2021
(86) PCT No.: PCT/EP2021/083104

§ 371 Date: May 18, 2023

(30) Foreign Application Priority Data
Nov. 27, 2020 (EP) 20210213.3

(51) Int. Cl. H01M 4/36; H01M 4/505; H01M 4/525; C01G 53/00

(52) U.S. Cl. CPC H01M 4/364; H01M 4/505; H01M 4/525; C01G 53/44; H01M 2004/028

(57) ABSTRACT

The present invention provides a positive electrode active material for lithium-ion secondary batteries, comprising: (i) a first lithium transition metal oxide, comprising single-crystalline particles having a median particle size D50_{A} of between 3 μm and 15 μm, as determined by laser particle size analysis, and (ii) a second lithium transition metal oxide, comprising single-crystalline particles having a median particle size D50_{B} of between 0.5 μm and 3 μm, as determined by laser particle size analysis, wherein a weight fraction φ_{B} of said second lithium transition metal oxide with respect to the total weight of said positive electrode active material is between 5 wt. % and 40 wt. %.

### TECHNICAL FIELD

This invention relates to a positive electrode active material powder for lithium-ion rechargeable batteries (LIBs).

In particular, the invention relates to a such a positive electrode material which is a Li—Ni—Mn—Co oxide or a Li—Ni—Co—Al oxide, and which is mainly or completely formed of single-crystalline particles.

Such a single-crystalline positive electrode active material powder is already known, for example from WO 2019/185349 A1, which a preparation process of the single-crystalline positive electrode active material powders. In its ideal form, the powder consists of dense “monolithic” particles, wherein each particle is a single crystal body instead of being a secondary particle. Such single-crystalline particles have a higher mechanical strength, leading to a better cycle stability in a battery.

However, the packed density in a battery positive electrode of such a positive electrode active material is relatively low due a relatively large amount of porosity being present between the particles, so that such a positive electrode occupies a relatively large volume.

It is an object of the present invention to provide a positive electrode active material which is advantageous in that it has a higher density after compaction, and therefore a higher density in a battery electrode, than the known single crystalline Li—Ni—Mn—Co or Li—Ni—Co—Al oxides.

### SUMMARY OF THE INVENTION

This objective is achieved by providing a positive electrode active material for lithium-ion rechargeable batteries whereby said positive electrode active material comprises Li, a metal M′, and oxygen, wherein the metal M′ comprises Ni, Co, and either Mn or Al and optionally one or more elements selected from: B, Ba, Sr, Mg, Nb, Ti, W, F, and Zr, whereby the positive electrode active material is a mixture of lithium transition metal oxide powders, whereby the mixture comprises a first lithium transition metal oxide powder and a second lithium transition metal oxide powder which are both single-crystalline powders, whereby the first lithium transition metal oxide powder constitutes a first weight fraction φ_{A} of the positive electrode active material and has a first median particle size D50_{A} of between 3 μm and 15 ρm, as determined by laser diffraction particle size analysis, whereby the second lithium transition metal oxide powder constitutes a second weight fraction φ_{B} of the positive electrode active material and has a second median particle size D50_{B} of between 0.5 μm and 3 μm, as determined by laser diffraction particle size analysis, whereby the second weight fraction φ_{B} is between 5 wt. % and 40 wt. %.

It is observed that a higher pressed density is achieved using a positive electrode active material according to the present invention, as illustrated by examples and supported by the results provided in Table 1. EX1.4 teaches a positive electrode active material comprising a first lithium transition metal oxide and a second transition metal oxide wherein the first single-crystalline lithium transition metal oxide has a higher median particle size than the second single-crystalline lithium transition metal oxide.

### BRIEF DESCRIPTION OF THE FIGURES

By means of further guidance, a figure is included to better appreciate the teaching of the present invention. Said figure is intended to assist the description of the invention and is nowhere intended as a limitation of the presently disclosed invention.

FIG. 1 shows a Scanning Electron Microscope (SEM) image of a positive electrode active material powder according to EX1.4 with a first single-crystalline lithium transition metal oxide and a second single-crystalline lithium transition metal oxide.

FIG. 2 shows a graphical presentation of the pressed density (Y-axis, expressed in g/cm³) of EX 1.1-1.5 and CEX 1.5 as a function of the weight fraction φ_{B} (X-axis, expressed in wt. %) of the second single-crystalline lithium transition metal oxide, relative to the total weight of the positive electrode active material.

FIG. 3 shows a graphical presentation of the pressed density (Y-axis, expressed in g/cm³) of EX 1-4 (φ_{B}=25 wt. %) and CEX 2 as a function of the ratio of D50_{A} of a first single-crystalline lithium transition metal oxide to D50_{B} of a second single-crystalline lithium transition metal oxide (D50_{A}/D50_{B}) (X-axis).

FIGS. 4, respectively 5 show the particle size distributions of samples EX 1.4 respectively EX 3.1.

### DETAILED DESCRIPTION OF THE INVENTION

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention. As used herein, the following terms have the following meanings:

“About” as used herein referring to a measurable value such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less of and from the specified value, in so far such variations are appropriate to perform in the disclosed invention. However, it is to be understood that the value to which the modifier “about” refers is itself also specifically disclosed.

The recitation of numerical ranges by endpoints includes all numbers and fractions subsumed within that range, as well as the recited endpoints. All percentages are to be understood as percentage by weight, abbreviated as “wt. %” or as volume per cent, abbreviated as “vol. %”, unless otherwise defined or unless a different meaning is obvious to the person skilled in the art from its use and in the context wherein it is used.

### Positive Electrode Active Material

In a first aspect, the present invention provides a positive electrode active material for lithium-ion rechargeable batteries,

whereby said positive electrode active material comprises Li, a metal M′, and oxygen, wherein the metal M′ comprises Ni, Co, and either Mn or Al and optionally one or more elements selected from: B, Ba, Sr, Mg, Nb, Ti, W, F, and Zr,

whereby the positive electrode active material is a mixture of lithium transition metal oxide powders,

whereby the mixture comprises a first lithium transition metal oxide powder and a second lithium transition metal oxide powder which are both single-crystalline powders,

whereby the first lithium transition metal oxide powder constitutes a first weight fraction φ_{A} of the positive electrode active material and has a first median particle size D50_{A} of between 3 μm and 15 μm, as determined by laser diffraction particle size analysis,

whereby the second lithium transition metal oxide powder constitutes a second weight fraction φ_{B} of the positive electrode active material and has a second median particle size D50_{B} of between 0.5 μm and 3 μm, as determined by laser diffraction particle size analysis, whereby the second weight fraction φ_{B} is between 5 wt. % and 40 wt. %.

The concept of single-crystalline powders is well known in the technical field of positive electrode active material. It concerns powders having mostly single-crystalline particles. Such powder are a separate class of powders compared to poly-crystalline powders, which are made of particles which are mostly poly-crystalline. The skilled person can easily distinguish such these two classes of powders based on a microscopic image.

Single-crystal particles are also known in the technical field as monolithic particles, one-body particles or and mono-crystalline particles.

Even though a technical definition of a single-crystalline powder is superfluous, as the skilled person can easily recognize such a powder with the help of an SEM, in the context of the present invention, single-crystalline powders may be considered to be defined as powders in which 80% or more of the number of particles are single-crystalline particles. This may be determined on an SEM image having a field of view of at least 45 μm×at least 60 μm (i.e. of at least 2700 μm²), and preferably of: at least 100 μm×100 μm (i.e. of at least 10,000 μm²).

Single-crystalline particles are particles which are individual crystals or which are formed of a less than five, and preferably at most three, primary particles which are themselves individual crystals. This can be observed in proper microscope techniques like Scanning Electron Microscope (SEM) by observing grain boundaries.

For the determination whether particles are single-crystalline particles, grains which have a largest linear dimension, as observed by SEM, which is smaller than 20% of the median particle size D50 of the powder, as determined by laser diffraction, are ignored. This avoids that particles which are in essence single-crystalline, but which may have deposited on them several very small other grains, for instance a poly-crystalline coating, are inadvertently considered as not being a single-crystalline particles.

The inventors have found that a positive electrode active material for lithium-ion rechargeable batteries according to the invention allows a higher pressed density. This is illustrated by examples and the results provided in the Table 1. EX1.4 details a positive electrode active material comprising a first lithium transition metal oxide powder comprising single-crystalline particles having a median particle size D50_{A} of 8.7 μm and a second lithium transition metal oxide powder comprising single-crystalline particles having a median particle size D50_{B} of 1.1 μm, wherein the weight ratio of said second lithium transition metal oxide powder with respect to the total weight of said positive electrode active material is 25 wt. %.

Preferably, the present invention provides a positive electrode active material according to the first aspect of the invention, whereby the second weight fraction φ_{B} is between 15 wt. % and 30 wt. % and preferably between 20 wt. % and 25 wt. %, and more preferably is equal to 15, 20, 25, 30 wt. % or any value there in between. The sum of the first weight fraction φ_{A} and the second weight fraction φ_{B} may be of at least 95% and preferably of at least 99%, more preferably of 100%.

Preferably, the present invention provides a positive electrode active material according to the first aspect of the invention, having whereby a ratio of the first median particle size D50_{A} to the second median particle size D50_{B} of between 4 and 30. Preferably, said ratio is between 5 and 15 and more preferably, said ratio is equal to 5, 7, 9, 11, 13, 15 or any value there in between.

In a preferred embodiment, said positive electrode active material according to the first aspect of the invention has a pressed density of at least 3.25 g/cm³, determined after applying a uni-axial pressure of 207 MPa for 30 seconds. Preferably, said positive electrode active material has a pressed density of at least 3.50 g/cm³, at least 3.55 g/cm³, at least 3.60 g/cm³, or even at least 3.65 g/cm³, or especially at least 3.70 g/cm³. Preferably, said positive electrode active material has a pressed density of at most 3.90 g/cm³, at most 3.85 g/cm³, at most 3.80 g/cm³, at most 3.75 g/cm³.

Preferably, the present invention provides a positive electrode active material according to the first aspect of the invention, whereby said first median particle size D50_{A} is between 4 and 15 μm, preferably between 5 μm and 10 μm and more preferably is equal to 5, 6, 7, 8, 9, 10 μm, or any alue there in between.

Preferably, the present invention provides a positive electrode active material according to the first aspect of the invention, wherein the first lithium transition metal oxide powder is a single crystalline powder and comprises Li, a metal M_{A}′, and oxygen, wherein the metal M_{A}′ has a general formula: Ni_{1-xa-ya-za} Mnₓₐ CO_{ya} A′_{za}, wherein 0.00≤xa≤0.30, 0.05 01≤ya≤0.20, and 0.00≤za≤0.01, wherein A′ comprises one or more elements selected from: B, Ba, Sr, Mg, Al, Nb, Ti, W, F, and Zr. More preferably, 0.05≤xa≤0.30, 0.04≤ya≤0.20, and 0.00≤za≤0.01.

The composition, i.e. the indices xa, ya, za, can be determined by known analysis methods, such as ICP-OES (Inductively coupled plasma—optical emission spectrometry).

Preferably, the present invention provides a positive electrode active material according to the first aspect of the invention, whereby said second median particle size D50_{B} is between 0.5 μm and 2 μm, preferably between 0.5 μm and 1.5 μm.

Preferably, the present invention provides a positive electrode active material according to the first aspect of the invention, whereby said second lithium transition metal oxide powder comprises Li, a metal M_{B}′, and oxygen, wherein the M_{B}′ has a general formula Ni_{1-xb-yb-zb} Mn_{xb} Co_{yb} A″_{zb} with 0.00≤xb≤0.35, 0.01≤yb≤0.35, and 0≤zb≤0.01, wherein A″ comprises one or more elements selected from: B, Ba, Sr, Mg, Al, Nb, Ti, W, F, and Zr. More preferably, 0.05≤xb≤0.30, 04≤yb≤0.20, and 0.00≤zb≤0.01.

In a second aspect, the present invention provides a process for manufacturing a positive electrode active material, preferably the positive electrode active material according to the first aspect of the invention, whereby the method comprises a step of mixing a first lithium transition metal oxide powder having a volume based particle size distribution with a first median particle size D50_{A} of between 3 μm and 15 μm, as determined by laser diffraction particle size analysis, with a second lithium transition metal oxide powder having a volume based particle size distribution with a second median particle size D50_{B} of between 0.5 μm and 3 μm, as determined by laser diffraction particle size analysis, whereby the first lithium transition metal oxide powder and the second lithium transition metal oxide powder are both single-crystalline powders, whereby a weight fraction φ_{B} of said second lithium transition metal oxide powder with respect to the total weight of said positive electrode active material is between 5 wt. % and 40 wt. %.

Preferably, said weight fraction φ_{B} of said second lithium transition metal oxide powder with respect to the total weight of said positive electrode active material is between 15 wt. % and 30 wt. %, preferably between 20 wt. % and 25 wt. %. Preferably, a ratio of said median particle size D50_{A} to said second median particle size D50_{B} (D50_{A}/D50_{B}) is between 2 and 20, preferably between 4 and 10, more preferably between 6 and 8.

In a third aspect, the present invention provides a battery cell comprising a positive electrode active material according to the first aspect of the invention.

In a fourth aspect, the present invention provides a use of a positive electrode active material according to the first aspect of the invention in a battery of either one of a portable computer, a tablet, a mobile phone, an electrically powered vehicle, and an energy storage system.

Particle size distributions of a mixtures can easily be calculated from particle size distributions of the constituents of the mixtures. Therefore, the invention can alternatively be defined by the following clauses:

Clause 1.—A positive electrode active material for lithium-ion rechargeable batteries, whereby said positive electrode active material comprises Li, a metal M′, and oxygen, wherein the metal M′ comprises Ni, Co, and either Mn or Al and optionally one or more elements selected from: B, Ba, Sr, Mg, Nb, Ti, W, F, and Zr, whereby the powder is a single-crystalline powder, whereby the powder has a volume based overall particle size distribution, characterized in that the overall particle size distribution is a multi-modal particle size distribution, whereby the overall particle size distribution comprises a first partial particle size distribution which has a first peak particle size and which forms a first volume fraction of the overall particle size distribution, whereby the overall particle size distribution comprises a second partial particle size distribution which has a second peak particle size and which forms a second volume fraction of the overall particle size distribution, whereby the first peak particle size lies between 4 μm and 15 μm, whereby the second peak particle size lies between 0.5 μm and 2 μm, whereby the second fraction is between 5 vol. % and 40 vol. % of the overall particle size distribution.

Clause 2.—Positive electrode active material according to clause 1, whereby the ratio of the first peak particle size to the second peak particle size is between 2 and 20.

Clause 3.—Positive electrode active material according to clause 1, whereby the ratio of the first peak particle size to the second peak particle size is between 4 and 10 and preferably between 6 and 8.

Clause 4.—Positive electrode active material according to any of the previous clauses, whereby said first peak particle size is between 5 μm and 10 μm.

Clause 5.—Positive electrode active material according to any of the previous clauses, whereby said second peak particle size is between 0.5 μm and 1.5 μm.

Clause 6.—Positive electrode active material according to any of the previous clauses, whereby the second fraction is between 15 vol. % and 30 vol. % and preferably between vol. % and vol. % of the overall particle size distribution.

Clause 7.—Positive electrode active material according to any of the previous clauses, whereby said positive electrode active material has a pressed density of at least 3.50 g/cm³.

Clause 8.—Positive electrode active material according to any of the previous clauses, whereby the particles in said first volume fraction have a composition that is different from the composition of the particles in said second volume fraction.

Clause 9.—Positive electrode active material according to any of the previous clauses, whereby the particles in said first volume fraction have a composition that comprises Li, a metal M_{A}′, and oxygen, wherein M_{A}′ has a general formula Ni_{1-xa-ya-za} Mnₓₐ Co_{ya} A′_{za} with 0.00≤xa≤0.30, 0.01≤ya≤0.20, and 0.00≤za≤0.01, wherein A′ comprises one or more elements selected from: Mn, B, Ba, Sr, Mg, Al, Nb, Ti, W, F, and Zr.

Clause 10.—Positive electrode active material according to any of the previous clauses, whereby the particles in said second volume fraction have a composition that comprises Li, a metal M_{B}′, and oxygen, wherein M_{B}′has a general formula Ni_{1-xb-yb-zb} Mn_{xb} Co_{yb} A″_{zb} with 0.00≤xb≤0.35, 0.01≤yb≤0.35, and 0≤zb≤0.01, wherein A″ comprises one or more elements selected from: B, Ba, Sr, Mg, Al, Nb, Ti, W, F, and Zr.

Clause 11.—Positive electrode active material according to any of the previous clauses, whereby the powder is obtained by mixing a first lithium transition metal oxide powder having a particle size distribution with a median particle size D50_{A} of between 4 μm and 15 μm, as determined by laser diffraction particle size analysis, with a second lithium transition metal oxide powder having a particle size distribution with a median particle size D50_{B} of between 0.5 μm and 2 μm, as determined by laser diffraction particle size analysis.

Clause 12.—Positive electrode active material according to any of the previous clauses, whereby the powder is obtained by mixing a first lithium transition metal oxide powder having a particle size distribution corresponding to the first partial particle size distribution with a second lithium transition metal oxide powder having a particle size distribution corresponding to the second partial particle size distribution.

Clause 13.—Positive electrode active material according to any of the previous clauses, whereby the positive electrode active material consists of the first volume fraction and the second volume fraction.

Clause 14.—Positive electrode active material according to any of the previous clauses, whereby the first volume fraction is between 5 vol. % and 40 vol. % of the sum of the first volume fraction and the second volume fraction.

Clause 15.—Method for manufacturing a positive electrode active material according to any of the previous clauses, whereby the method comprises a step of mixing a first lithium transition metal oxide powder having a volume based particle size distribution with a median particle size D50_{A} of between 4 μm and 15 μm, as determined by laser diffraction particle size analysis, with a second lithium transition metal oxide powder having a volume based particle size distribution with a median particle size D50_{B} of between 0.5 μm and 2 μm, as determined by laser diffraction particle size analysis, whereby the first lithium transition metal oxide powder and the second lithium transition metal oxide powder are both single-crystalline powders, whereby a weight fraction φ_{B} of said second lithium transition metal oxide powder with respect to the total weight of said positive electrode active material is between 5 wt. % and 40 wt. %.

Clause 16.—Method according to clause 15, whereby said weight fraction φ_{B} of said second lithium transition metal oxide powder with respect to the total weight of said positive electrode active material is between 15 wt. % and 30 wt. %, preferably between 20 wt. % and 25 wt. %.

Clause 17.—Battery cell comprising a positive electrode active material according to any of clauses 1 to 14.

Clause 18.—Use of a positive electrode active material according to any of clauses 1 to 14 in a battery of either one of a portable computer, a tablet, a mobile phone, an electrically powered vehicle, and an energy storage system.

In such positive electrode active material according to any of the mentioned clauses, the first peak particle size and second peak particle size can usually be easily visually determined from a measured particle size distribution, eg measured by laser diffraction. If needed, well-known peak deconvolution algorithms may be used.

### EXAMPLES

The following examples are intended to further clarify the present invention and are nowhere intended to limit the scope of the present invention.

### 1. Description of Analysis Method

### 1.1. Inductively Coupled Plasma

The composition of a positive electrode active material powder is measured by the inductively coupled plasma (ICP) method using an Agilent 720 ICP-OES (Agilent Technologies, https://www.agilent.com/cs/library/brochures/5990-6497EN%20720-725_ICP-OES_LR.pdf). 1 gram of powder sample is dissolved into 50 mL of high purity hydrochloric acid (at least 37 wt. % of HCl with respect to the total weight of solution) in an Erlenmeyer flask. The flask is covered by a watch glass and heated on a hot plate at 380° C. until the powder is completely dissolved. After being cooled to room temperature, the solution from the Erlenmeyer flask is poured into a first 250 mL volumetric flask. Afterwards, the first volumetric flask is filled with deionized water up to the 250 mL mark, followed by a complete homogenization process (1^{st} dilution). An appropriate amount of the solution from the first volumetric flask is taken out by a pipette and transferred into a second 250 mL volumetric flask for the 2^{nd} dilution, where the second volumetric flask is filled with an internal standard element and 10% hydrochloric acid up to the 250 mL mark and then homogenized. Finally, this solution is used for ICP measurement.

### 1.2. Pressed Density

The pressed density is measured as follows: 3 grams of powder is filled into a pellet die with a diameter “d” of 1.30 cm. A uniaxial load pressure of 207 MPa is applied to the powder in pellet die for 30 seconds. After relaxing the load, the thickness “t” of the pressed powder is measured. The pellet density is then calculated as (3/(n*(d/2)²*t)) with units g/cm³.

### 1.3. SEM (Scanning Electron Microscope) Analysis

The morphology of positive electrode active materials is analyzed by a Scanning Electron Microscopy (SEM) technique. The measurement is performed with a JEOL JSM 7100F under a high vacuum environment of 9.6×10⁻⁵ Pa at 25° C.

### 1.4. Particle Size Distribution

The particle size distribution (PSD) of the positive electrode active material powder is measured by laser diffraction particle size analysis using a Malvern Mastersizer 3000 with a Hydro MV wet dispersion accessory (https://www.malvernpanalytical.com/en/products/product-range/mastersizer-range/mastersizer-3000#overview) after having dispersed each of the powder samples in an aqueous medium. In order to improve the dispersion of the powder, sufficient ultrasonic irradiation and stirring is applied, and an appropriate surfactant is introduced. D50 is defined as the particle size at 50% of the cumulative volume % distributions obtained from the Malvern Mastersizer 3000 with Hydro MV measurements. Analogously D10 and D90 are defined as the particle sizes at 10%, respectively 90% of the cumulative volume % distributions.

### 2. Examples and Comparative Examples

### Comparative Example 1

A single-crystalline positive electrode active material labelled as CEX1.1 is prepared according to the following steps:
Step 1) Transition metal hydroxide precursor preparation: A nickel-based transition metal hydroxide powder (TMH1) having a general formula of transition metals of Ni_{0.62}Mn_{0.18}Co_{0.20} and a median particle size (D50) of 4 μm is prepared by a co-precipitation process in a large-scale continuous stirred tank reactor (CSTR) with mixed nickel manganese cobalt sulphates, sodium hydroxide, and ammonia.
Step 2) First mixing: the prepared TMH1 from Step 1) is mixed with LiOH in an industrial blender so as to obtain a first mixture having a lithium to metal (Li/(Ni+Mn+Co)) ratio of 0.90.
Step 3) First firing: the first mixture from Step 2) is fired at 750° C. for 12 hours under O₂ containing atmosphere in a furnace so as to obtain the first fired powder.
Step 4) Second mixture: the first fired powder from Step 3) is blended with LiOH in an industrial blender so as to obtain a second mixture having a lithium to metal (Li/(Ni+Mn+Co)) ratio of 1.045.
Step 5) Second firing: the second mixture from Step 4) is fired at 840° C. for 12 hours in an O₂ containing atmosphere in a furnace so as to obtain a second fired powder.
Step 6) Post-treatment: the second fired powder from Step 5) is grinded by a wet ball milling process to avoid the formation of agglomerates. The final product is a single-crystalline oxide powder labelled as CEX1.1.

The particle size distribution of CEX 1.1 was determined. CEX 1.1 had a D10 of 0.15 μm, a D50 of 1.12 μm and a D90 of 2.01 μm.

CEX1.2 is prepared according to the same method as CEX1.1 except that the second firing condition in Step 5) is 860° C. for 10 hours.

The particle size distribution of CEX 1.2 was determined. CEX 1.2 had a D10 of 1.08 μm, a D50 of 1.76 μm and a D90 of 2.82 μm.

CEX1.3 is prepared according to the same method as CEX1.1 except that the second firing condition in Step 5) is 880° C. for 10 hours.

The particle size distribution of CEX 1.3 was determined. CEX 1.3 had a D10 of 1.48 μm, a D50 of 2.46 μm and a D90 of 3.90 μm.

CEX1.4 is prepared according to the same method as CEX1.1 except that the second firing temperature in Step 5) is 920° C. for 10 hours.

The particle size distribution of CEX 1.4 was determined. CEX 1.4 had a D10 of 2.48 μm, a D50 of 4.17 μm and a D90 of 6.68 μm.

A single-crystalline positive electrode active material labelled as CEX1.5 is prepared according to the following steps:
Step 1) Transition metal hydroxide precursor preparation: A nickel-based transition metal hydroxide powder (TMH2) having a general formula of transition metals of Ni_{0.62}Mn_{0.18}Co_{0.20} and a median particle size (D50) of 10 μm is prepared by a co-precipitation process in a large-scale continuous stirred tank reactor (CSTR) with mixed nickel manganese cobalt sulphates, sodium hydroxide, and ammonia.
Step 2) First mixing: the prepared TMH2 from Step 1) is mixed with LiOH in an industrial blender so as to obtain a first mixture having a lithium to metal (Li/(Ni+Mn+Co)) ratio of 0.85.
Step 3) First firing: the first mixture from Step 2) is fired at 900° C. for 9 hours under air atmosphere in a furnace so as to obtain the first fired powder.
Step 4) Second mixture: the first fired powder from Step 3) is blended with LiOH in an industrial blender so as to obtain a second mixture having a lithium to metal (Li/(Ni+Mn+Co)) ratio of 1.065.
Step 5) Second firing: the second mixture from Step 4) is fired at 960° C. for 12 hours in an air atmosphere in a furnace so as to obtain a second fired powder.
Step 6) Post-treatment: the second fired powder from Step 5) is grinded by a wet ball milling process to avoid the formation of agglomerates. The final product is a single-crystalline oxide powder labelled as CEX1.5.

The particle size distribution of CEX 1.5 was determined. CEX 1.5 had a D10 of 4.89 μm, a D50 of 8.76 μm and a D90 of 14.7 μm.

### Example 1

EX1.1 is prepared by mixing a first transition metal oxide powder CEX1.5 with a second transition metal oxide powder CEX1.1 using an industrial blender with a 2^{nd} powder fraction of 8 wt. %. The 2^{nd} powder fraction is calculated by:

(2^{nd} powder weight/(2^{nd} powder weight+1^{st} powder weight))*100%.

EX1.2, EX1.3, EX1.4, and EX1.5 are prepared according to the same method as EX1.1 except that 2^{nd} powder fractions are 12, 20, 25, and 30 wt. %, respectively.

### Example 2

EX2 is prepared according to the same method as EX1.4 except that CEX1.2 is used as a second transition metal oxide powder.

### Example 3

EX3.1 is prepared according to the same method as EX1.1 except that CEX1.3 is used as a second transition metal oxide powder and the 2^{nd} powder fraction is 25 wt. %.

EX3.2 is prepared according to the same method as EX1.1 except that CEX1.3 is used as a second transition metal oxide powder and the 2^{nd} powder fraction is 30 wt. %.

### Example 4

A positive electrode active material labelled as EX4.1 is a mixture of EX4-A and EX4-B which are prepared according to the following steps:
Step 1) Preparing EX4-A, which is a single-crystalline positive electrode active material according to the procedure running as follows:
   a. Transition metal hydroxide precursor preparation: A nickel-based transition metal hydroxide powder (TMH5) having a general formula of transition metals of Ni_{0.86}Mn_{0.10}Co_{0.04} and a median particle size (D50) of 5 μm is prepared by a co-precipitation process in a large-scale continuous stirred tank reactor (CSTR) with mixed nickel manganese cobalt sulphates, sodium hydroxide, and ammonia.
   b. First mixing: the prepared TMHS from Step 1.a) is mixed with LiOH in an industrial blender so as to obtain a first mixture having a lithium to metal (Li/(Ni+Mn+Co)) ratio of 0.90.
   c. First firing: the first mixture from Step 1.b) is fired at 720° C. for 10 hours under O₂ containing atmosphere in a furnace so as to obtain the first fired powder.
   d. Second mixture: the first fired powder from Step 1.c) is blended with LiOH in an industrial blender so as to obtain a second mixture having a lithium to metal (Li/(Ni+Mn+Co)) ratio of 1.06.
   e. Second firing: the second mixture from Step 1.d) is fired at 830° C. for 12 hours in an O₂ containing atmosphere in a furnace so as to obtain a second fired powder.
   f. Post-treatment: the second fired powder from Step 1.e) is grinded by a wet ball milling process for 10 hours to avoid the formation of agglomerates. The final product is single-crystalline oxide powder labelled as EX4-A.
Step 2) Preparing EX4-B, which is a single-crystalline positive electrode active material according to the procedure running as follows:
   a. Transition metal hydroxide precursor preparation: A nickel-based transition metal hydroxide powder (TMH6) having a general formula of transition metals of Ni_{0.86}Mn_{0.10}Co_{0.04} and a median particle size (D50) of 5 μm is prepared by a co-precipitation process in a large-scale continuous stirred tank reactor (CSTR) with mixed nickel manganese cobalt sulphates, sodium hydroxide, and ammonia.
   b. First mixing: the prepared TMH6 from Step 2.a) is mixed with LiOH in an industrial blender so as to obtain a first mixture having a lithium to metal (Li/(Ni+Mn+Co)) ratio of 0.90.
   c. First firing: the first mixture from Step 2.b) is fired at 720° C. for 10 hours under O₂ containing atmosphere in a furnace so as to obtain the first fired powder.
   d. Second mixture: the first fired powder from Step 2.c) is blended with LiOH in an industrial blender so as to obtain a second mixture having a lithium to metal (Li/(Ni+Mn+Co)) ratio of 1.01.
   e. Second firing: the second mixture from Step 2.d) is fired at 950° C. for 12 hours in an O₂ containing atmosphere in a furnace so as to obtain a second fired powder.
   f. Post-treatment: the second fired powder from Step 2.e) is grinded by a wet ball milling process for 6 hours to avoid the formation of agglomerates. The final product is single-crystalline oxide powder labelled as EX4-B.

EX4-A had a D50 of 1.3 μm and a EX4-B had a D50 of 7.1 μm
Step 3) EX4.1 preparation: EX4-A and EX4-B are mixed with a weight ratio between EX4-A and EX4-B of 25 wt. %:75 wt. %. The product is labelled as EX4.1.

EX4.2 is prepared according to the same method as EX4.1 except that the weight ratio between EX4-A and EX4-B is 70 wt. %:30 wt. %.

EX5.1 is prepared according to the same method as EX1.4, except that CEX1.4 is used as the first transition metal oxide powder.

EX5.2 is prepared according to the same method as EX1.5, expect that CEX1.4 is used as the first transition metal oxide powder.

In all examples the compositions of the constituents of the final product are the same. Therefore, their densities of the constituents are the same, so that a certain weight ratio of constituents in the final products corresponds to numerically the same volume ratio of these constituents in the final products.

Particle size distributions of the final products do not need to be measured but can be easily calculated from the particle size distributions of the constituents and their relative proportions.

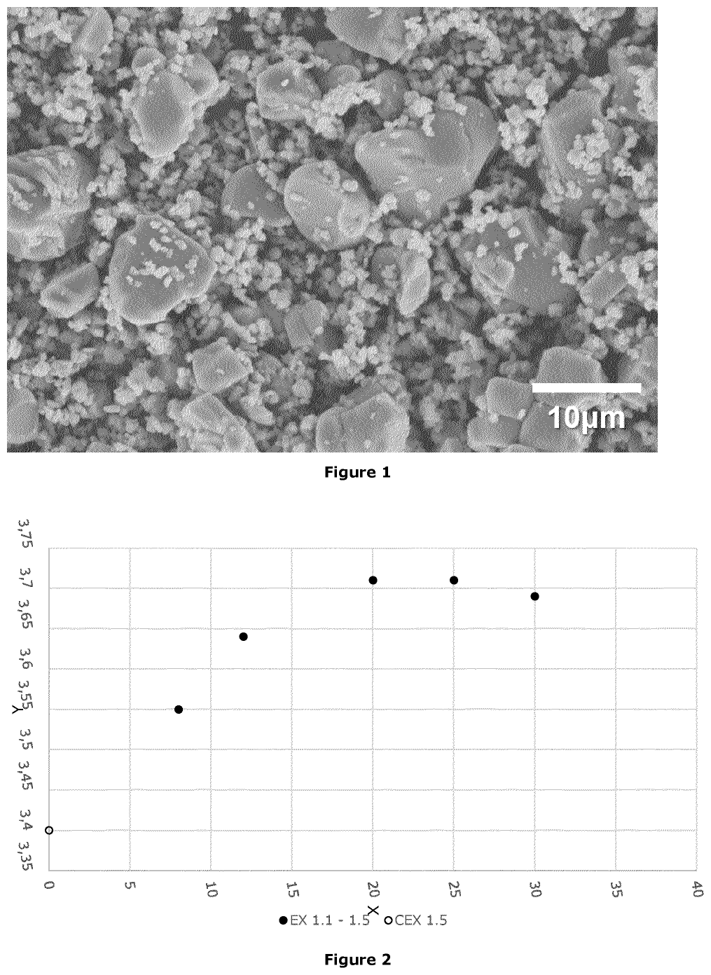

FIG. 1 shows that the SEM image of EX1.4 which comprises a first single-crystalline powder and a second single-crystalline powder wherein their median particle sizes are different.

Table 1 summarizes the composition of examples and comparative examples and their corresponding pressed density.

TABLE 1
Summary of the composition and the corresponding pressed
density of example and comparative examples.

| | | | | 2^{nd} powder | | Pressed |
|---|---|---|---|---|---|---|
| | Ni/(Ni + Mn + Co) | 1^{st} powder | 2^{nd} powder | fraction | | density |
| ID | (mol/mol) | D50_{A} (μm) | D50_{B} (μm) | φ_{B} (wt. %) | D50_{A}/D50_{B} | (g/cm³) |
| CEX1.1 | 0.62 | 1.1 | — | — | — | 3.06 |
| CEX1.2 | 0.62 | 1.7 | — | — | — | 3.11 |
| CEX1.3 | 0.62 | 2.4 | — | — | — | 3.21 |
| CEX1.4 | 0.62 | 4.2 | — | — | — | 3.29 |
| CEX1.5 | 0.62 | 8.7 | — | — | — | 3.40 |
| EX1.1 | 0.62 | 8.7 | 1.1 | 8 | 7.9 | 3.55 |
| EX1.2 | 0.62 | 8.7 | 1.1 | 12 | 7.9 | 3.64 |
| EX1.3 | 0.62 | 8.7 | 1.1 | 20 | 7.9 | 3.71 |
| EX1.4 | 0.62 | 8.7 | 1.1 | 25 | 7.9 | 3.71 |
| EX1.5 | 0.62 | 8.7 | 1.1 | 30 | 7.9 | 3.69 |
| EX2 | 0.62 | 8.7 | 1.7 | 25 | 5.1 | 3.68 |
| EX3.1 | 0.62 | 8.7 | 2.4 | 25 | 3.6 | 3.53 |
| EX3.2 | 0.62 | 8.7 | 2.4 | 30 | 3.6 | 3.50 |
| EX4.1 | 0.86 | 7.1 | 1.3 | 25 | 5.7 | 3.70 |
| EX4.2 | 0.86 | 7.1 | 1.3 | 30 | 5.7 | 3.68 |
| EX5.1 | 0.62 | 4.2 | 1.1 | 25 | 3.8 | 3.42 |
| EX5.2 | 0.62 | 4.2 | 1.1 | 30 | 3.8 | 3.43 |

CEX1.1 to CEX1.5 are the single-crystalline lithium transition metal oxide powder having D50 ranging from 1.1 μm to 8.7 μm. It is appeared that the use of single-crystalline lithium transition metal oxide powder alone is failed to meet the objective of this invention as pressed density does not exceed 3.40 g/cm³.

EX1.1, EX1.2, EX1.3, EX1.4, and EX1.5 are mixtures of CEX1.5 and CEX1.1 with different fractions φ_{B} of CEX1.1 (2^{nd} powder fraction). They all have higher pressed densities than CEX1.5. The pressed density is further optimized when the 2^{nd} powder fraction is between 20 wt. % and 25 wt. %, as can be clearly seen from FIG. 2.

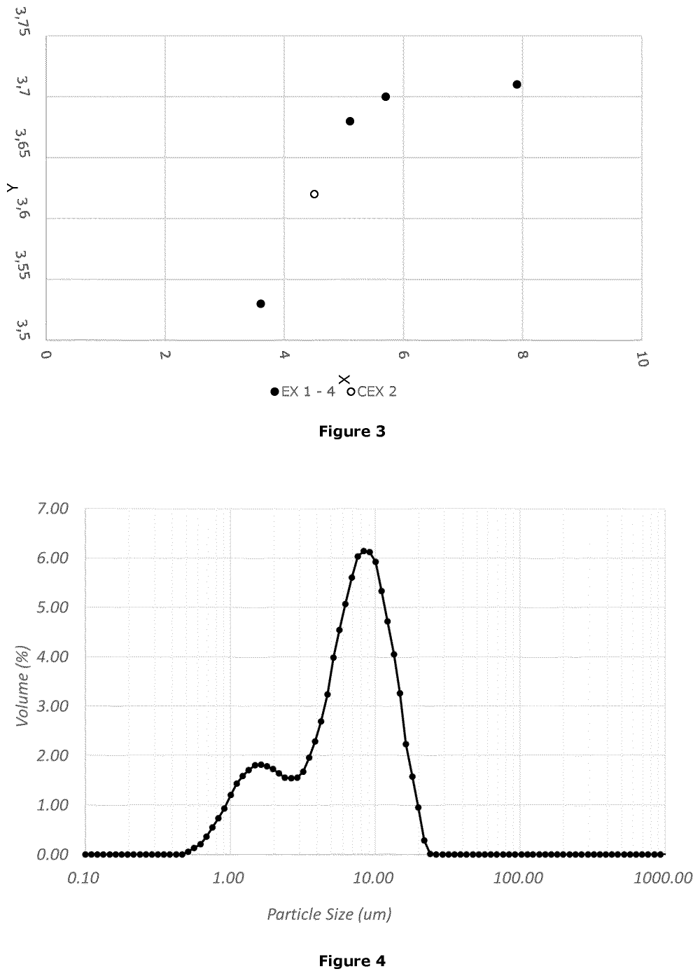

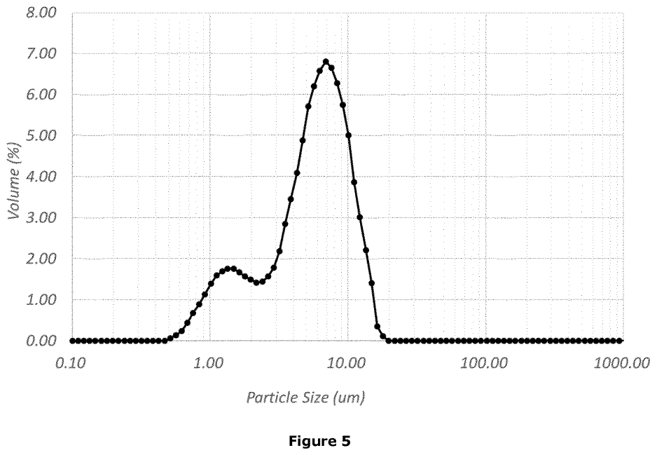

EX1.4, EX2, and EX1.3 are mixtures of CEX1.5 (as 1^{st} powder) and CEX1.1, CEX1.2, and CEX1.3 (as 2^{nd} powder), respectively, wherein the 2^{nd} powder fraction φ_{B} is 25 wt. %. All examples have higher pressed densities than CEX1.5. The pressed density is further optimized when the ratio of the median particle size of the 1^{st} powder (D50_{A}) to the median particle size of the 2^{nd} powder (D50_{B}), which is D50_{A}/D50_{B}, is superior or equal to 4.0, and more preferably between 6 and 8, as can be clearly seen from FIG. 3.

EX4.1 and EX4.2 have a higher Ni molar content with respect to the total molar contents of transition metals than other abovementioned examples. EX4.1 and EX4.2 meet the objective of this invention.

EX5.1 and EX5.2 are mixtures of CEX1.4 (as 1^{st} powder) and CEX1.1 (as 2^{nd} powder). Both are showing higher pressed density in comparison with the comparative example an exceeding the objective of the invention.

1-17. (canceled)

18. A positive electrode active material for lithium-ion secondary batteries, whereby said positive electrode active material comprises Li, a metal M′, and oxygen, wherein the metal M′ comprises Ni, Co, and either Mn or Al and optionally one or more elements selected from: B, Ba, Sr, Mg, Nb, Ti, W, F, and Zr,
wherein the positive electrode active material is a mixture of lithium transition metal oxide powders,
wherein the mixture comprises a first lithium transition metal oxide powder and a second lithium transition metal oxide powder which are both single-crystalline powders,
wherein the first lithium transition metal oxide powder constitutes a first weight fraction φ_{A} of the positive electrode active material and has a first median particle size D50_{A} of between 3 μm and 15 μm, as determined by laser diffraction particle size analysis,
wherein the second lithium transition metal oxide powder constitutes a second weight fraction φ_{B} of the positive electrode active material and has a second median particle size D50_{B} of between 0.5 μm and 3 μm, as determined by laser diffraction particle size analysis,
wherein the second weight fraction φ_{B} is between 5 wt. % and 40 wt. %.

19. Positive electrode active material according to claim 18, wherein said first median particle size D50_{A} is between 4 μm and 15 μm.

20. Positive electrode active material according to claim 18, wherein said first median particle size D50_{A} is between 0.5 μm and 2 μm.

21. Positive electrode active material according to claim 18, wherein a ratio of the first median particle size D50_{A} to the second median particle size D50_{B} is between 2 and 20.

22. Positive electrode active material according to claim 18, wherein a ratio of the first median particle size D50_{A} and the second median particle size D50_{B} is between 4 and 10.

23. Positive electrode active material according to claim 18, wherein said first median particle size D50_{A} is between 5 μm and 10 μm.

24. Positive electrode active material according to claim 18, wherein said second median particle size D50_{B} is between 0.5 μm and 1.5 μm.

25. Positive electrode active material according to claim 18, wherein said second weight fraction φ_{B} is between 15 wt. % and 30 wt. %.

26. Positive electrode active material according to claim 18, wherein said positive electrode active material has a pressed density, after applying a uniaxial pressure of 207 MPa for 30 seconds, of at least 3.50 g/cm³.

27. Positive electrode active material according to claim 18, wherein said first lithium transition metal oxide powder comprises Li, a metal M_{A}′, and oxygen, wherein M_{A}′ has a general formula Ni_{1-xa-ya-za} Mnₓₐ CO_{ya} A′_{za} with 0.00≤xa≤0.30, 0.01≤ya≤0.20, and 0.00≤za≤0.01, wherein A′ comprises one or more elements selected from: Mn, B, Ba, Sr, Mg, Al, Nb, Ti, W, F, and Zr.

28. Positive electrode active material according to claim 18, wherein said second lithium transition metal oxide powder comprises Li, a metal M_{B}′, and oxygen, wherein the M_{B}′ has a general formula Ni_{1-xb-yb-zb} Mn_{xb} Co_{yb} A″_{zb} with 0.00≤xb≤0.35, 0.01≤yb≤0.35, and 0≤zb≤wherein A″ comprises one or more elements selected from: B, Ba, Sr, Mg, Al, Nb, Ti, W, F, and Zr.

29. Positive electrode active material according to claim 18, wherein the sum of the first weight fraction φ_{A} and the second weight fraction φ_{B} is at least 95%.

30. Method for manufacturing a positive electrode active material wherein the method comprises a step of mixing a first lithium transition metal oxide powder having a volume based particle size distribution with a first median particle size D50_{A} of between 3 μm and 15 μm, as determined by laser diffraction particle size analysis, with a second lithium transition metal oxide powder having a volume based particle size distribution with a second median particle size D50_{B} of between 0.5 μm and 3 μm, as determined by laser diffraction particle size analysis, whereby the first lithium transition metal oxide powder and the second lithium transition metal oxide powder are both single-crystalline powders, whereby a weight fraction φ_{B} of said second lithium transition metal oxide powder with respect to the total weight of said positive electrode active material is between 5 wt. % and 40 wt. %.

31. Method according to claim 30, wherein said weight fraction φ_{B} is between 15 wt. % and 30 wt. %.

32. Method according to claim 30, wherein the positive electrode active material comprises Li, a metal M′, and oxygen, wherein the metal M′ comprises Ni, Co, and either Mn or Al and optionally one or more elements selected from: B, Ba, Sr, Mg, Nb, Ti, W, F, and Zr, wherein the positive electrode active material is a mixture of lithium transition metal oxide powders, wherein the mixture comprises a first lithium transition metal oxide powder and a second lithium transition metal oxide powder which are both single-crystalline powders, wherein the first lithium transition metal oxide powder constitutes a first weight fraction φ_{A} of the positive electrode active material and has a first median particle size D50_{A} of between 3 μm and 15 μm, as determined by laser diffraction particle size analysis, wherein the second lithium transition metal oxide powder constitutes a second weight fraction φ_{B} of the positive electrode active material and has a second median particle size D50_{B} of between 0.5 μm and 3 μm, as determined by laser diffraction particle size analysis, and wherein the second weight fraction φ_{B} is between 5 wt. % and 40 wt. %.

33. Battery cell comprising a positive electrode active material according to claim 18.
